(19) United States
(12) Patent Application Publication
(10) Pub. No.: US 2026/0107216 A1
(43) Pub. Date: Apr. 16, 2026

(54) HANDLING SYSTEM INFORMATION FROM MULTIPLE SOURCES IN A COMMUNICATION SYSTEM

(71) Applicant: QUALCOMM Incorporated, San Diego, CA (US)

(72) Inventors: Shankar KRISHNAN, Poway, CA (US); Gavin Bernard HORN, La Jolla, CA (US); Karl Georg HAMPEL, Jersey City, NJ (US); Karthika PALADUGU, Hyderabad (IN); Ozcan OZTURK, San Diego, CA (US)

(21) Appl. No.: 18/913,861

(22) Filed: Oct. 11, 2024

(51) Int. Cl. H04W 48/08

(52) U.S. Cl. CPC H04W 48/08

(57) ABSTRACT

Methods, systems, and devices for wireless communications are described herein. In some examples, a first network entity may obtain, from a second network entity, first information elements (IEs) including first system information (SI). The first network entity may obtain, from a third network entity, second IEs including second SI. The first network entity may generate one or more third IEs including a combination of or selection between the first IEs and the second IEs based on policy information for SI conflict resolution. The first network entity may output, based on the policy information, an SI configuration that includes the one or more third IEs associated with the obtained first IEs, the obtained second IEs, or any combination thereof.

### FIELD OF TECHNOLOGY

The following relates to wireless communications, including handling system information from multiple sources in a communication system.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first network entity is described. The method may include obtaining, from a second network entity, one or more first information elements (IEs) including first system information (SI), obtaining, from a third network entity, one or more second IEs including second SI, and outputting, based on policy information for SI, an SI configuration that includes one or more third IEs associated with the obtained one or more first IEs, the obtained one or more second IEs, or any combination thereof.

A first network entity for wireless communications is described. The first network entity may include one or more memories storing processor executable code, and one or more processors coupled with the one or more memories. The one or more processors may individually or collectively be operable to execute the code to cause the first network entity to obtain, from a second network entity, one or more first IEs including first SI, obtain, from a third network entity, one or more second IEs including second SI, and output, based on policy information for SI, an SI configuration that includes one or more third IEs associated with the obtained one or more first IEs, the obtained one or more second IEs, or any combination thereof.

Another first network entity for wireless communications is described. The first network entity may include means for obtaining, from a second network entity, one or more first IEs including first SI, means for obtaining, from a third network entity, one or more second IEs including second SI, and means for outputting, based on policy information for SI, an SI configuration that includes one or more third IEs associated with the obtained one or more first IEs, the obtained one or more second IEs, or any combination thereof.

A non-transitory computer-readable medium storing code for wireless communications is described. The code may include instructions executable by one or more processors to obtain, from a second network entity, one or more first IEs including first SI, obtain, from a third network entity, one or more second IEs including second SI, and output, based on policy information for SI, an SI configuration that includes one or more third IEs associated with the obtained one or more first IEs, the obtained one or more second IEs, or any combination thereof.

Some examples of the method, first network entities, and non-transitory computer-readable medium described herein may further include operations, features, means, or instructions for generating the SI configuration based on aggregating at least one first IE of the obtained one or more first IEs and at least one second IE of the obtained one or more second IEs according to the policy information.

In some examples of the method, first network entities, and non-transitory computer-readable medium described herein, aggregating the at least one first IE and the at least one second IE may include operations, features, means, or instructions for concatenating the at least one first IE with the at least one second IE to form a combined system IE with SI from both of the second network entity and the third network entity, where the SI configuration includes the combined system IE.

In some examples of the method, first network entities, and non-transitory computer-readable medium described herein, aggregating the at least one first IE and the at least one second IE may include operations, features, means, or instructions for aggregating the at least one first IE and the at least one second IE based on one or more rules associated with the at least one first IE, the at least one second IE, or any combination thereof.

Some examples of the method, first network entities, and non-transitory computer-readable medium described herein may further include operations, features, means, or instructions for selecting the obtained one or more first IEs or the obtained one or more second IEs based on the policy information and generating the SI configuration based on selecting the obtained one or more first IEs or the obtained one or more second IEs.

Some examples of the method, first network entities, and non-transitory computer-readable medium described herein may further include operations, features, means, or instructions for outputting, to the second network entity based on outputting the SI configuration, first feedback including conflict resolution information that indicates which first IEs of the obtained one or more first IEs were included in the SI configuration, which second IEs of the obtained one or more second IEs were included in the SI configuration, one or more aggregation techniques used to generate the SI configuration, or any combination thereof and outputting, to the third network entity based on outputting the SI configuration, second feedback including the conflict resolution information that indicates which first IEs of the obtained one or more first IEs were included in the SI configuration, which second IEs of the obtained one or more second IEs were included in the SI configuration, the one or more aggregation techniques used to generate the SI configuration, or any combination thereof.

In some examples of the method, first network entities, and non-transitory computer-readable medium described herein, the first feedback further includes first information associated with at least one first IE of the obtained one or more first IEs not included in the SI configuration; or the second feedback further includes second information associated with at least one second IE of the obtained one or more second IEs not included in the SI configuration; or any combination thereof.

Some examples of the method, first network entities, and non-transitory computer-readable medium described herein may further include operations, features, means, or instructions for outputting, to the second network entity, a first request for the second network entity to output the first SI, where obtaining the first SI may be based on the first request and outputting, to the third network entity, a second request for the third network entity to output the second SI, where receiving the second SI may be based on the second request.

Some examples of the method, first network entities, and non-transitory computer-readable medium described herein may further include operations, features, means, or instructions for obtaining, from a fourth network entity, signaling indicating the policy information, the policy information including first policy information associated with the second network entity, second policy information associated with the third network entity, or any combination thereof, where respective policy information associated with a network entity includes one or more of a priority of the network entity with respect to another network entity, an application or service associated with the network entity, a policy or rule provided by of the network entity, or any combination thereof.

In some examples of the method, first network entities, and non-transitory computer-readable medium described herein, outputting the SI configuration may include operations, features, means, or instructions for outputting the SI configuration via broadcast signaling, multicast signaling, unicast signaling, or any combination thereof.

In some examples of the method, first network entities, and non-transitory computer-readable medium described herein, obtaining the one or more first IEs, obtaining the one or more second IEs, or any combination thereof may include operations, features, means, or instructions for obtaining the one or more first IEs, obtaining the one or more second IEs, or any combination thereof via a point-to-point interface in accordance with a request and response signaling type.

In some examples of the method, first network entities, and non-transitory computer-readable medium described herein, obtaining the one or more first IEs, obtaining the one or more second IEs, or any combination thereof may include operations, features, means, or instructions for obtaining the one or more first IEs, obtaining the one or more second IEs, or any combination thereof via a service-based interface (SBI) using application programming interfaces in accordance with a subscribe and notify signaling type.

In some examples of the method, first network entities, and non-transitory computer-readable medium described herein, the first SI, the second SI, or any combination thereof includes information for cell selection, information for cell reselection, information for transmitting notifications, timing information, initial access information, information for sidelink communication, positioning information, information for one or more reference signal configurations, information associated with one or more channel configurations, information associated with outputting the SI configuration, or any combination thereof.

In some examples of the method, first network entities, and non-transitory computer-readable medium described herein, the first network entity includes a distributed unit (DU) or a radio access network (RAN) entity, and the second network entity and the third network entity each include one or more of a central unit (CU), a RAN entity, a server, an operations, administration, and management (OAM) protocol, or an SI service.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports handling system information from multiple sources in a communication system in accordance with one or more aspects of the present disclosure.

FIG. 2 shows an example of a network architecture that supports handling system information from multiple sources in a communication system in accordance with one or more aspects of the present disclosure.

FIG. 3 shows an example of a wireless communications system that supports handling system information from multiple sources in a communication system in accordance with one or more aspects of the present disclosure.

FIG. 4 shows an example of a process flow that supports handling system information from multiple sources in a communication system in accordance with one or more aspects of the present disclosure.

FIGS. 5 and 6 show block diagrams of devices that support handling system information from multiple sources in a communication system in accordance with one or more aspects of the present disclosure.

FIG. 7 shows a block diagram of a communications manager that supports handling system information from multiple sources in a communication system in accordance with one or more aspects of the present disclosure.

FIG. 8 shows a diagram of a system including a device that supports handling system information from multiple sources in a communication system in accordance with one or more aspects of the present disclosure.

FIGS. 9 through 11 show flowcharts illustrating methods that support handling system information from multiple sources in a communication system in accordance with one or more aspects of the present disclosure.

### DETAILED DESCRIPTION

In some wireless communications systems, system information (SI) may be transmitted or otherwise exchanged between two or more network entities before a network entity may broadcast the SI (e.g., via a system information block (SIB)) to user equipments (UEs) or other wireless devices. For example, in a disaggregated system, a central unit (CU) may transmit SI (e.g., via one or more information elements (IEs)) to one or more associated distributed units (DUs). In some systems, a DU may be in communication with more than one source of SI, and the DU may obtain SI from multiple sources (e.g., CUs, servers). For example, a DU may receive SI from two or more CUs, servers, or other sources. In some examples, the DU may receive conflicting SI from two or more sources, such as differing types of SI, conflicting SI of the same type, partial SI (e.g., partial SIBs), or the like from multiple sources. Techniques or protocols for aggregating, combining, or otherwise selecting, by a network entity, which SI to forward to one or more UEs when the network entity receives SI from more than one source may be beneficial.

The techniques described herein may support a network entity (e.g., DU, radio access network (RAN) entity) to receive IEs related to SI from multiple sources (e.g., CUs, RAN entities, servers, SI services, and the like) and to generate an SI configuration, in accordance with policy information for SI conflict resolution, to output some combination of or selection from the received SI to one or more UEs. The network entity may obtain, from a second network entity, one or more first IEs that include first SI. The network entity may also obtain, from a third network entity, one or more second IEs that include second SI. The network entity described herein may generate, according to policy information (e.g., rules, policies, role, priorities, applications, or the like), an SI configuration by aggregating one or more of the received IEs, selecting between the one or more received IEs from the second network entity and the third network entity, or performing a combination of aggregation and selection, in some examples.

For example, if the first SI and the second SI at least partially conflict, such as if they include at least a portion of the same type of SI (e.g., the same SIB), the network entity may select, based on roles, priorities, policies, or applications associated with the network entities, between the first IEs and the second IEs to generate the SI configuration. Additionally, or alternatively, the first SI and the second SI may be at least partially different (e.g., different SIBs, partial SI of the same SIB). In these cases, the network entity may concatenate, aggregate, or otherwise combine one or more of the first IEs and the second IEs to generate the SI configuration. The network entity may output the SI configuration to one or more UEs based on the combination, selection, or any combination thereof. The policy information described herein may thereby provide rules and protocols for a network entity to follow when the network entity receives SI from multiple sources. By following the policy information described herein, a network entity may select or combine the most relevant and accurate SI, as compared with systems in which the selection may be random, which may improve throughput and reliability of wireless communications, among other examples.

Aspects of the disclosure are initially described in the context of wireless communications systems, network architectures, and process flows. Aspects of the disclosure are further illustrated by and described herein with reference to apparatus diagrams, system diagrams, and flowcharts that relate to handling SI from multiple sources in a communication system.

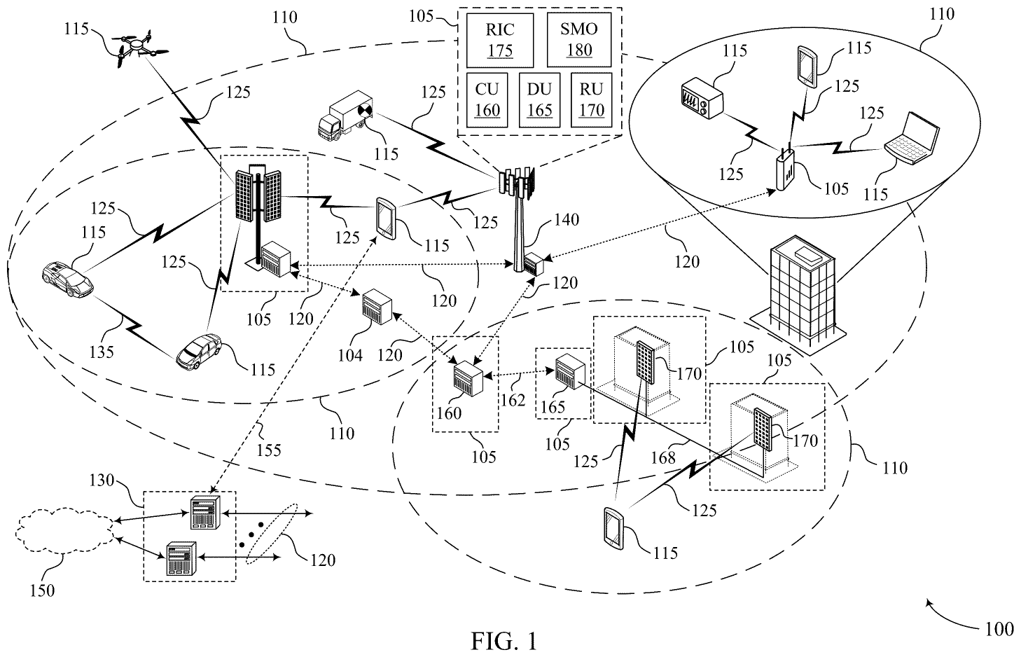

FIG. 1 shows an example of a wireless communications system 100 that supports handling SI from multiple sources in a communication system in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a CU, such as a CU 160, a DU, such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support handling SI from multiple sources in a communication system as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, SI), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, SI may be transmitted or otherwise exchanged between two or more network entities 105 before a network entity 105 may broadcast the SI (e.g., a SIB) to UEs 115 or other wireless devices. For example, in a disaggregated system, a CU may transmit SI (e.g., via one or more IEs) to one or more associated DUs. In some systems, a DU may be in communication with more than one source, and the DU may obtain SI from multiple sources (e.g., CUs, servers). For example, a DU may receive SI from two or more CUs. In some examples, the DU may receive conflicting SI from two or more sources, such as differing types of SI, conflicting SI of the same type, partial SI (e.g., partial SIBs), or the like from multiple sources, and the DU may not support techniques or protocols for aggregating, combining, or otherwise selecting which SI to forward to one or more UEs.

A network entity 105 (e.g., DU, RAN entity) may receive IEs related to SI from multiple sources (e.g., CUs, RAN entity, servers, SI services) and generate an SI configuration to output some combination of or selection from the received SI to one or more UEs 115. The network entity 105 may obtain, from a second network entity 105 (e.g., a CU, server, or other source of SI), one or more first IEs that include first SI. The network entity may also obtain, from a third network entity 105 (e.g., a CU, server, or other source of SI), one or more second IEs that include second SI. The network entity 105 described herein may generate, according to policy information (e.g., rules, policies, role, priorities, applications, or the like), an SI configuration by aggregating one or more of the received IEs, selecting between the one or more received IEs from the second network entity 105 and the third network entity 105, or performing a combination of aggregation and selection, in some examples.

For example, if the first SI and the second SI at least partially conflict, such as if they include at least a portion of the same type of SI (e.g., the same SIB), the network entity 105 may select, based on roles, priorities, policies, or applications associated with the network entities, between the first IEs and the second IEs to generate the SI configuration. Additionally, or alternatively, the first SI and the second SI may be at least partially different (e.g., different SIBs, partial SI of the same SIB). In these cases, the network entity 105 may concatenate, aggregate, or otherwise combine one or more of the first IEs and the second IEs to generate the SI configuration. The network entity 105 may output the SI configuration to one or more UEs 115 based on the combination, selection, or any combination thereof.

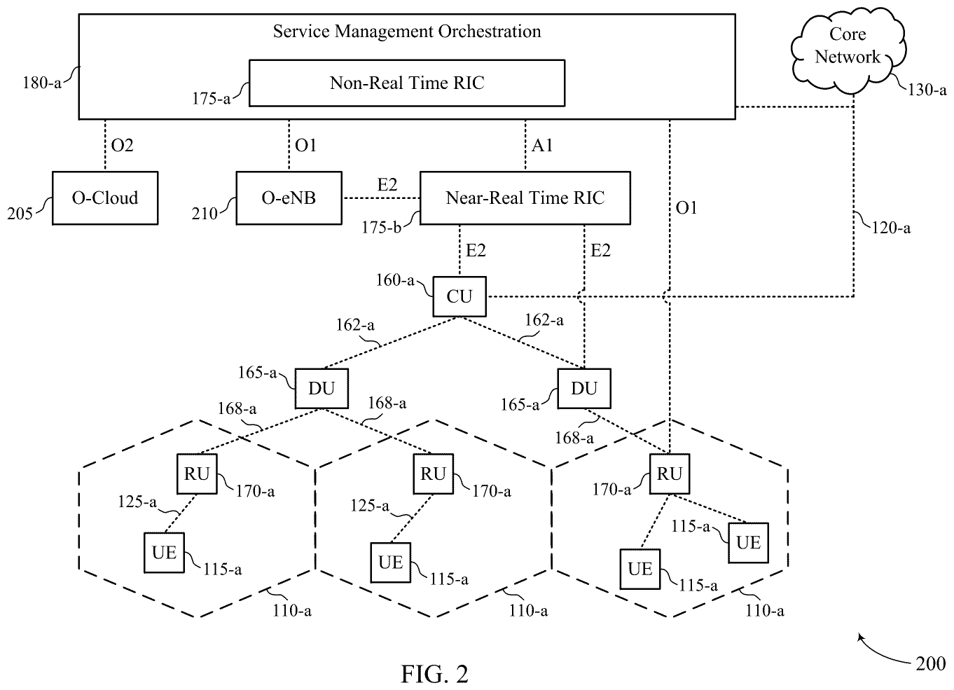

FIG. 2 shows an example of a network architecture 200 (e.g., a disaggregated base station architecture, a disaggregated RAN architecture) that supports handling SI from multiple sources in a communication system in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO system 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO system 180-a may be configured to support RAN deployment and provisioning of non-virtualized and virtualized network entities 105. For non-virtualized network entities 105, the SMO system 180-a may be configured to support the deployment of dedicated physical resources for RAN coverage requirements which may be managed via an operations and maintenance interface (e.g., an O1 interface). For virtualized network entities 105, the SMO system 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO system 180-a may communicate with components configured in accordance with a 4G RAN (e.g., via an O1 interface). Additionally, or alternatively, in some implementations, the SMO system 180-a may communicate directly with one or more RUs 170-a via an O1 interface. The SMO system 180-a also may include a Non-RT RIC 175-a configured to support functionality of the SMO system 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO system 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO system 180-a (e.g., reconfiguration via O1) or via generation of RAN management policies (e.g., A1 policies).

In some cases, the network architecture 200 may support various communications of SI. Each network function or device of the network architecture 200 may have a particular role, job, or the like for handling SI. For example, a DU 165-a (e.g., gNB-DU) may encode some SIB (e.g., SIB1, SIB10, SIB12 SIB13, SIB14, SIB15, SIB17, SIB18, SIB20, SIB22, SIB23, SIB24), which may be known as DU-generated SIBs or DU-SIBs. The DU 165-a may broadcast the DU-SIBs in coverage areas 110-a (e.g., cells) that the DU 165-a may serve, or the DU 165-a may output the DU-SIBs to a CU 160-a via an RRC container, for example. The DU 165-a may provide the RRC container as a setup request (e.g., F1 setup request) or a configuration or reconfiguration update for the DU 165-a (e.g., a DU 165-a configuration update). In some examples, a CU 160-a (e.g., gNB-CU) may encode other SIBs, which may be referred to as CU-generated SIBs or CU-SIBs. The CU 160-a may generate CU-SIBs and may output, via an RRC container, both the DU-SIBs and the CU-SIBs to the DU 165-a. In some cases, the CU 160-a may also provide or indicate the SIB type, RRC container, value tag, area scope, or area identification (e.g., SystemInformationAreaID) to the DU 165-a. In some examples, the CU 160-a may output the SIBs and associated information in a setup request response (e.g., F1 setup response), a configuration update feedback message (e.g., DU 165-a Configuration Update Ack), or a configuration or reconfiguration update for the CU 160-a (e.g., CU 160-a configuration update). The DU 165-a may store the received or obtained SIBs, and may broadcast the SIBs to the coverage areas 110-a (e.g., cells) served by the DU 165-a.

In some examples, a management entity (e.g., SMO system 180-a) may configure the CUs 160-a, DUs 165-a, or any combination thereof (e.g., each network function, network entity, network device) with instructions, authorizations, or indications of trust. For static configurations, the management entities may utilize a network configuration protocol (NETCONF) that may allow the management entities to configure or manage network devices. Each network entity (e.g., CUs 160-a, DUs 165-a) may follow the configuration of the management entities. For example, the DU 165-a may be configured or indicated to control or manage admission control and resource allocation based on one or more service level agreements (SLAs). The management entity may grant the DU 165-a flexible access to multiple other network functions or entities, such as through various configurations, indications, or commands (e.g., OAuth). For example, the DU 165-a may access or communicate with multiple CUs 160-a, which may allow for dynamic policy enforcement.

In some cases, the CU 160-a may control, configure, or reconfigure the DU 165-a, such as reconfiguring or deactivating cells that the DU 165-a may interact with. However, in some wireless communications systems, one DU 165-a may be shared or may receive SI from multiple CUs 160-a. This functionality may be enabled as part of an architecture design or network design (e.g., zero trust architecture design). That is, in some systems, a DU 165-a may be in communication with more than one source (e.g., CU 160-a, server, SI service), and the DU 165-a may obtain SI from multiple sources (e.g., CUs 160-a, servers, SI services). For example, there may conflicting requests from multiple CUs 160-a received at the DU 165-a and the DU 165-a may determine which CU 160-a to utilize the SI from, or whether the SI may be aggregated. In some cases, each CU 160-a may have a priority or a role, which may be specific to the DU 165-a. For example, a DU 165-a may have a primary CU 160-a, and the primary CU 160-a may have priority to control the DU 165-a, such as for cell reconfiguration, deactivation, or activation. In some cases, for non-conflicting tasks, priority roles may be redundant (e.g., for UE-related tasks).

In some examples, the DU 165-a may receive conflicting SI from two or more sources, such as differing types of SI, conflicting SI of the same type, partial SI (e.g., partial SIBs), or the like from multiple sources. Techniques described herein provide for policy information (e.g., protocols, rules, or the like) configured for SI conflict resolution and aggregation by the DU 165-a. For example, the policy information may be configured at the DU 165-a or otherwise indicated to the DU 165-a and may include protocols, rules, or parameters for aggregating, combining, or otherwise selecting which SI to forward to one or more UEs 115-a. For example, a network entity (e.g., DU 165-a, RAN) may receive IEs related to SI from multiple sources (e.g., CUs 160-a, servers, SI services) and generate an SI configuration to output some combination of or selection from the received SI to one or more UEs 115-a. The network entity may obtain, from a second network entity (e.g., a CU 160-a, server, SI service, or other source of SI), one or more first IEs that include first SI. The network entity may also obtain, from a third network entity (e.g., a CU 160-a, server, SI service, or other source of SI), one or more second IEs that include second SI. The network entity described herein may generate, according to policy information (e.g., rules, policies, role, priorities, applications, or the like), an SI configuration by aggregating one or more of the received IEs, selecting between the one or more received IEs from the second network entity and the third network entity, or performing a combination of aggregation and selection, in some examples.

For example, if the first SI and the second SI at least partially conflict, such as if they include at least a portion of the same type of SI (e.g., the same SIB), the network entity may select, based on roles, priorities, policies, or applications associated with the network entities, between the first IEs and the second IEs to generate the SI configuration. Additionally, or alternatively, the first SI and the second SI may be at least partially different (e.g., different SIBs, partial SI of the same SIB). In these cases, the network entity may concatenate, aggregate, or otherwise combine one or more of the first IEs and the second IEs to generate the SI configuration. The network entity may output the SI configuration to one or more UEs 115-a based on the combination, selection, or any combination thereof.

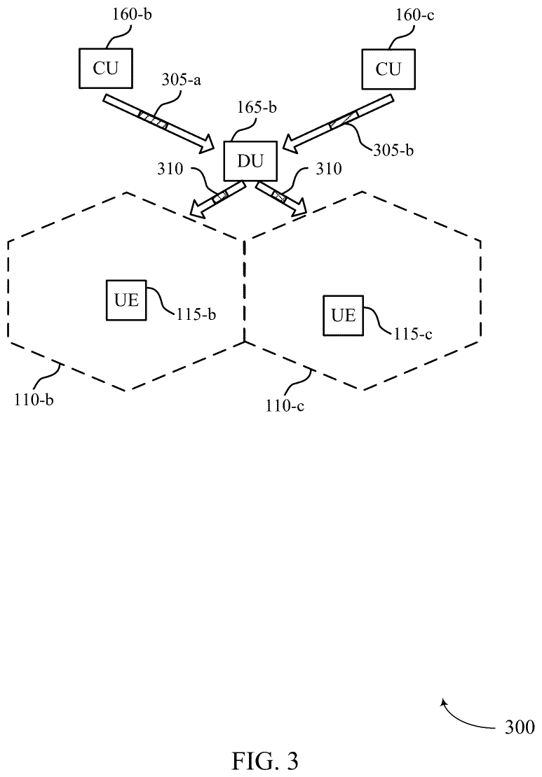

FIG. 3 shows an example of a wireless communications system 300 that supports handling SI from multiple sources in a communication system in accordance with one or more aspects of the present disclosure. The wireless communications system 300 may implement, or be implemented by, aspects of the wireless communications system 100 or the network architecture 200. For example, the wireless communications system 300 may include one or more CUs 160, DUs 165, and UEs 115, which may be examples of corresponding devices as described herein, including with reference to FIGS. 1 and 2. The techniques described herein in the context of the wireless communications system 300 may support methods for a network entity to select, aggregate, or any combination thereof, IEs to generate an SI configuration for sending to one or more UEs 115. A network entity as described herein may represent an example of any one of the CUs 160, DUs 165, or other entities described herein, such as servers, SI services, or the like.

In some wireless communication systems 300, the signaling exchange between network entities as described herein may use a point-to-point interface (e.g., frequency 1 (F1) interface). In some cases, the point-to-point interface may utilize a request and response type of signaling. In some implementations, the signaling exchange described herein may use a service-based interface (SBI), which may include application programming interfaces (APIs). In some cases, the SBI may be associated with a subscribe and notify type of signaling. For example, a DU 165-b may subscribe to one or more CUs 160 (e.g., give the CUs 160 instructions on a frequency with which to send SI) and the CUs 160 may, based on the subscription, regularly transmit SI to the subscribed DU 165-b.

In some examples, as illustrated in the wireless communications system 300, multiple CUs 160 may share a DU 165. That is, multiple CUs 160 may be in communication with and may output or transmit SI-related IEs 305 (e.g., IEs 305 including SI) to a same DU 165. For example, both CU 160-b and CU 160-c may control, configure, or otherwise communicate with DU 165-b. For example, the DU 165-b may receive IEs 305-a from CU 160-b and the DU 165-b may receive IEs 305-b from CU 160-c. In some implementations, the IEs 305 may include SI used for cell selection or cell reselection (e.g., intra-frequency, inter-frequency, inter-RAT cell selection or reselection), for sending notifications (e.g., Earthquake and Tsunami Warning System (ETWS) or Commercial Mobile Alert Service (CMAS) notifications), for time or location information (e.g., global positioning SI, coordinated universal time information), initial access (e.g., to cells, coverage areas 110), sidelink or vehicle-to-everything (V2X) communication, ranging or positioning, reference signal configuration (e.g., tracking reference signals (TRS)) for UEs 115 in different connectivity modes (e.g., idle, inactive modes), multicast channel configuration (e.g., multicast control channel (MCCH) configuration, multicast traffic channel (MTCH) configuration), or broadcast-related information. In some cases, the IEs may include periodicities for transmitting or outputting the SI configuration 310 towards the UEs 115, an area scope within which SI may be transmitted, value tags, or any combination thereof.

In some implementations, the DU 165-b may request the IEs 305 from the respective CUs 160. That is, for example, the IEs 305-a may be provided from the CU 160-b based on a request from the DU 165-b. Additionally, or alternatively, the IEs 305 may be pushed to the DU 165-b by the respective CUs 160. For example, the CU 160-b may output the IEs 305-a to the DU 165-b without a request from the DU 165-b. In some examples, the DU 165-b may determine or the CUs 160 may indicate which CU 160 the respective IEs 305 may be output by based on an identification, a uniform resource locator (URL), or the like.

In some cases, the CU 160-b may send IEs 305-a including first SI (e.g., a SIB, SIBX)) to the DU 165-b and the CU 160-c may send IEs 305-b including the same first SI (e.g., the same SIB or same type of SIB (e.g., SIBX)) to the DU 165-b. This may result in conflicting SI (e.g., conflicting SIBs) at the DU 165-b. In some cases, the CU 160-b may send IEs 305-a including first SI to the DU 165-b and the CU 160-c may send, to the DU 165-b, IEs 305-b including second SI different from the first SI. For example, the CU 160-b and the CU 160-c may be examples of purpose-specific CUs 160, and may both output IEs 305 including different SIBs, types of SIBs, or SI based on the specific purposes associated with each CU 160. In some examples, this may not result in conflicting SI. However, techniques for the DU 165-b to aggregate the different IEs 305-a and the IEs 305-b may be beneficial and are described herein. In some cases, the CU 160-b may send, to the DU 165-b, IEs 305-a that may include parts of a SIB (e.g., partial SI of SIBX) and the CU 160-c may send, to the DU 165-b, IEs 305-b that may include other parts of the SIB (e.g., partial SI of SIBX). In some examples, this may not result in conflicting SI. However, techniques for the DU 165-b to aggregate the IEs 305-a and the IEs 305-b may be beneficial and are described herein.

After receiving the IEs 305, the DU 165-b may generate an SI configuration 310 (e.g., a final SI configuration 310) based on the received IEs 305-a and 305-b in order to output some combination of or selection from the received SI to one or more UEs 115. That is, generating the SI configuration 310 may include either a selection, an aggregation, or any combination thereof among the multiple IEs 305 received from the multiple CUs 160. In some cases, the DU 165-b may select among the obtained IEs 305-a and the obtained IEs 305-b based on policy information for SI associated with the CUs 160, such as roles, priorities, or policies associated with the respective CUs 160. For example, the CUs 160 may be purpose-specific (e.g., a CU 160 for Redcap, a CU 160 for non-terrestrial networks (NTN), a CU 160 for ETWS) or may have defined roles towards the DU 165-b (e.g., primary CU 160, secondary CU 160). The CUs 160 may also be associated with respective priorities, which, in some cases, may be based on the purpose, the role, or any combination thereof of the CU 160.

The policy information may be configured at the DU 165-b. In some examples, the policy information, such as the roles, priorities, or policies associated with the respective CUs 160, may be configured at the DU 165-b by an operations, administration, and management (OAM) system or another entity or network entity (e.g., network repository function (NRF)), or may be dynamically provided (e.g., upon request, upon configuration or update, or the like). In some cases, the DU 165-b may use some intelligent processing, logical decision making, algorithm, or the like to implement the policy information.

As described herein, if the SI included in the IEs 305-a and the SI included in the IEs 305-b at least partially conflict, such as if they include at least a portion of the same type of SI (e.g., the same SIB), the DU 165-b may select, based on roles, priorities, policies, or applications associated with the CUs 160-b (i.e., policy information), between the first IEs 305-a and the second IEs 305-b. That is, the DU 165-b may decide, determine, select, or the like whether to output the SI included in the IEs 305-a or the IEs 305-b based on the policy information configured or indicated at the DU 165-b. The DU 165-b may generate an SI configuration 310 based on the selected IEs 305. That is, the DU 165-b may generate the SI configuration 310 based on selecting among the obtained IEs 305-a and the obtained IEs 305-b.

Additionally, or alternatively, the SI included in the IEs 305-a and the SI included in the IEs 305-b may be at least partially different (e.g., different SIBs, partial SI of the same SIB). In these cases, as described herein, the DU 165-b may concatenate, aggregate, or otherwise combine one or more of the IEs 305-a and the IEs 305-b to generate an SI configuration 310. That is, the DU 165-b may aggregate the SI (e.g., the SIBs, the parts of the SIB) from the IEs 305-a and the IEs 305-b to form combined SI (e.g., a SIB), and may then output both the SI from the IEs 305-a and the SI from the IEs 305-b in the SI configuration 310 (e.g., both SIBs, a combined SIBX). For example, in some cases, the DU 165-b may aggregate the IEs 305-a obtained from the CU 160-b and the IEs 305-b obtained from the CU 160-c and may generate a combined SI configuration 310 as the final SI configuration 310. The DU 165-b may output the SI configuration 310 to one or more UEs 115 based on the combination, selection, or any combination thereof.

In some cases, the DU 165-b may provide feedback to the CU 160-b and feedback to the CU 160-c. The feedback may indicate which of the IEs 305-a, the IEs 305-b, or both were included in the SI configuration 310. Additionally, or alternatively, the feedback may indicate to a respective CU 160 whether the IEs 305 associated with the CU 160 were used in the SI configuration 310. Additionally, or alternatively, the feedback may indicate to a respective CU 160 which IEs 305 were not included in the SI configuration 310 and, in some cases, may further indicate a reason or cause for why the IEs 305 were not included or selected. In some implementations, the DU 165-b may provide feedback to the respective CUs 160 based on receiving a request from the respective CU 160. For example, the DU 165-b may provide feedback to the CU 160-b if the CU 160-b requests feedback. Additionally, or alternatively, the DU 165-b may push the feedback to the respective CUs 160. For example, the DU 165-b may output the feedback to the CU 160-b and the CU 160-c without requests from the respective CUs 160.

The DU 165-b may transmit or output the SI configuration 310 to the respective coverage areas 110 (e.g., cells) that the DU 165-b may serve. The UEs 115 may receive or obtain the SI configuration 310. In some cases, a UE 115-b may receive the SI configuration 310, which may not indicate information about the SI configuration 310 generation that may have occurred at the DU 165-b, or even indicate that the SI configuration 310 generation occurred at all. In other cases, the SI configuration 310 may include some indication of the SI configuration 310 generation through some metadata, assistance information, or the like. In some examples, the DU 165-b may output the SI configuration 310 to the UEs 115 via broadcast, multicast, or unicast signaling (e.g., RRC, medium access control control element (MAC-CE), or layer 1 signaling (L1)).

Although DU 165-b, CU 160-b, and 160-c are provided as illustrative examples of functions or devices supporting the techniques described herein, the techniques described herein may also be performed by other devices or functions. For example, the DU 165-b may receive IEs 305 from entities other than CUs 160, such as OAMs, SI services, servers, or any combination thereof. In some examples, such as non-split architecture, a CU 160 and DU 165 may not be considered separate entities, and may instead be considered a RAN, which may obtain IEs 305 or SI in general from entities such as OAMs, SI services, servers, other CUs 160, or any combination thereof. The techniques described herein as being performed by a CU 160 or a DU 165 may also be performed by OAMs, SI services, or servers, or RANs, respectively.

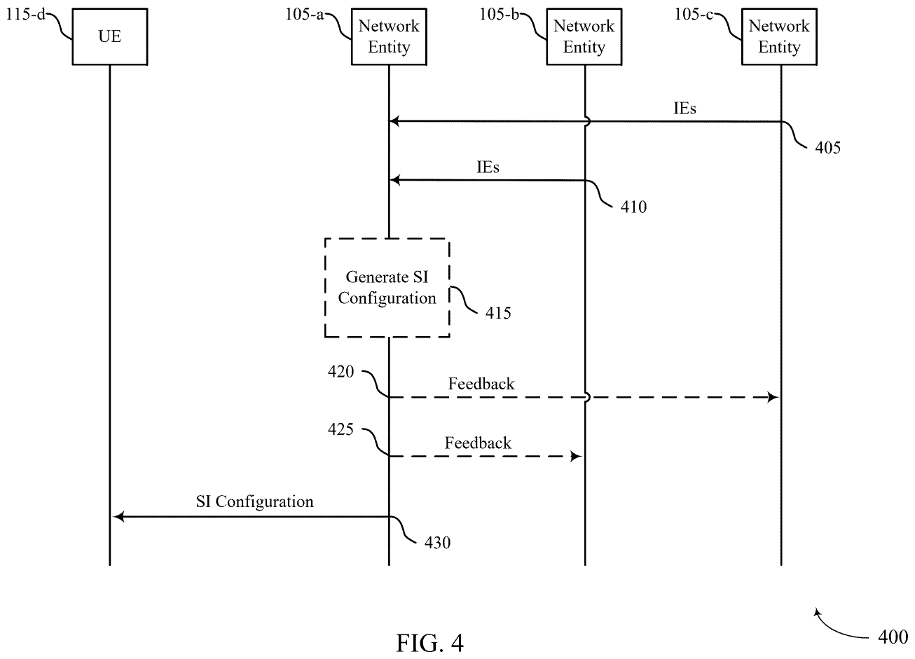

FIG. 4 shows an example of a process flow 400 that supports handling SI from multiple sources in a communication system in accordance with one or more aspects of the present disclosure. The process flow 400 may implement, or be implemented by, aspects of the wireless communications systems 100 or 300, or the network architecture 200. For example, the wireless communications system 300 may include network entities 105 and UEs 115, which may be examples of corresponding devices as described herein, including with reference to FIGS. 1-3. The techniques described herein in the context of process flow 400 may support methods for a network entity to select, aggregate, or any combination thereof, IEs to generate and output an SI configuration.

At 405, a first network entity 105-a (e.g., DU, RAN) may obtain, from a second network entity 105-b (e.g., CU, server, SI service, OAM protocol) one or more first IEs including first SI. In some cases, the first SI may include information for cell selection, information for cell reselection, information for transmitting notifications, timing information, initial access information, information for sidelink communication, positioning information, information for one or more reference signal configurations, information associated with one or more channel configurations, information associated with outputting the SI configuration, or any combination thereof. In some examples, the first network entity 105-a may obtain the one or more first IEs via a point-to-point interface in accordance with a request and response signaling type. Additionally, or alternatively, the first network entity 105-a may obtain the one or more first IEs via an SBI using APIs in accordance with a subscribe and notify signaling type.

In some cases, the first network entity 105-a may obtain the one or more first IEs at 405 in response to outputting a request. For example, the first network entity 105-a may output, to the second network entity 105-b, a first request for the second network entity 105-b to output the first SI, where obtaining the first SI is based on the first request. In some cases, the first network entity 105-a may include a DU, such as the DUs 165 described herein. Additionally, or alternatively, the first network entity 105-a may include a RAN entity (e.g., RAN node). That is, the first network entity 105-a may include a DU or a RAN entity. In some cases, the second network entity 105-b may include a CU, such as the CUs 160 as described herein. Additionally, or alternatively, the second network entity 105-b may include a server, an OAM protocol, or an SI service. That is, the second network entity 105-b may include one or more of a CU, a RAN entity, a server, an OAM protocol, or an SI service.

At 410, the first network entity 105-a may obtain, from a third network entity 105-c (e.g., CU, server, SI service, OAM protocol) one or more second IEs including second SI. In some cases, the second SI may include information for cell selection, information for cell reselection, information for transmitting notifications, timing information, initial access information, information for sidelink communication, positioning information, information for one or more reference signal configurations, information associated with one or more channel configurations, information associated with outputting the SI configuration, or any combination thereof. In some examples, the first network entity 105-a may obtain the one or more second IEs via a point-to-point interface in accordance with a request and response signaling type. Additionally, or alternatively, the first network entity 105-a may obtain the one or more second IEs via an SBI using APIs in accordance with a subscribe and notify signaling type.

In some cases, the first network entity 105-a may obtain the one or more second IEs at 410 in response to outputting a request. For example, the first network entity 105-a may output, to the third network entity 105-c, a second request for the third network entity 105-c to output the second SI, where obtaining the second SI is based on the second request. In some cases, the third network entity 105-c may include a CU, such as the CUs 160 as described herein. Additionally, or alternatively, the third network entity 105-c may include a server, a RAN entity, an OAM protocol, or an SI service. That is, the second network entity 105-b may include one or more of a CU, a RAN entity, a server, an OAM protocol, or an SI service.

In some implementations, at 415, the first network entity 105-a may generate an SI configuration (e.g., a final SI configuration, SI configuration 310). In some cases, the first network entity 105-a may generate the SI configuration based on aggregating at least one first IE of the obtained one or more first IEs and at least one second IE of the obtained one or more second IEs according to policy information for SI. In some examples, aggregating the at least one first IE and the at least one second IE may include concatenating the at least one first IE with the at least one second IE to form a combined system information element with SI from both of the second network entity 105-b and the third network entity 105-c, where the SI configuration includes the combined system information element. In some cases, aggregating the at least one first IE and the at least one second IE may include aggregating the at least one first IE and the at least one second IE based on one or more rules associated with the at least one first IE, the at least one second IE, or any combination thereof. For example, the aggregation may be based on a first parameter included in the at least one first IE satisfying one or more first thresholds associated with the policy information and a second parameter included in the at least one second IE satisfying one or more second thresholds associated with the policy information.

In some cases, the first network entity 105-a may select the obtained one or more first IEs or the obtained one or more second IEs based on the policy information and may generate the SI configuration at 415 based on selecting the obtained one or more first IEs or the obtained one or more second IEs. For example, the obtained one or more first IEs may conflict with the obtained one or more second IEs. The first network entity 105-a may select between the one or more first IEs and the one or more second IEs to generate the SI configuration. The selection may be based on the policy information.

The policy information may include first policy information associated with the second network entity 105-b, second policy information associated with the third network entity 105-c, or any combination thereof, where respective policy information associated with a network entity may include one or more of a priority of the network entity with respect to another network entity, an application or service associated with the network entity, a policy or rule provided by of the network entity, or any combination thereof. In some cases, the first network entity 105-a may obtain, from a fourth network entity, signaling indicating the policy information (e.g., an RRC configuration or other indication).

In some implementations, at 420, the first network entity 105-a may output, to the second network entity 105-b based on outputting the SI configuration, as described herein with reference to 430, first feedback comprising conflict resolution information that indicates which first IEs of the obtained one or more first IEs were included in the SI configuration, which second IEs of the obtained one or more second IEs were included in the SI configuration, one or more aggregation techniques used to generate the SI configuration, or any combination thereof. In some examples, the first feedback may further include first information associated with at least one first IE of the obtained one or more first IEs not included in the SI configuration. In some cases, the first feedback may be output before outputting the SI configuration, as described herein with reference to 430, but after generating the SI configuration, as described herein with reference to 415. In other cases, the first feedback may be output after outputting the SI configuration, as described herein with reference to 430, or synchronously with the SI configuration.

In some implementations, at 425 the first network entity 105-a may output, to the third network entity 105-c based on outputting the SI configuration, as described herein with reference to 430, second feedback comprising conflict resolution information that indicates which first IEs of the obtained one or more first IEs were included in the SI configuration, which second IEs of the obtained one or more second IEs were included in the SI configuration, one or more aggregation techniques used to generate the SI configuration, or any combination thereof. In some examples, the second feedback may further include second information associated with at least one second IE of the obtained one or more second IEs not included in the SI configuration. In some cases, the second feedback may be output before outputting the SI configuration, as described herein with reference to 430, but after generating the SI configuration, as described herein with reference to 415. In other cases, the second feedback may be output after outputting the SI configuration, as described herein with reference to 430, or synchronously with the SI configuration. In some cases, the first network entity 105-a may output the first feedback, as described herein at 420, before the second feedback. In other cases, the first network entity 105-a may output the first feedback, as described herein at 420, after the second feedback. In other cases, the first network entity 105-a may output the first feedback and the second feedback synchronously.

At 430, the first network entity 105-a may output, based on the policy information for SI, the SI configuration that includes one or more third IEs associated with the obtained one or more first IEs, the obtained one or more second IEs, or any combination thereof. In some cases, the first network entity 105-a may output the SI configuration via broadcast signaling, multicast signaling, unicast signaling, or any combination thereof. The SI configuration may be received by the UE 115-d within a coverage area or cell. In some cases, outputting the SI configuration at 430 may be based on generating the SI configuration, as described further herein with reference to 415.

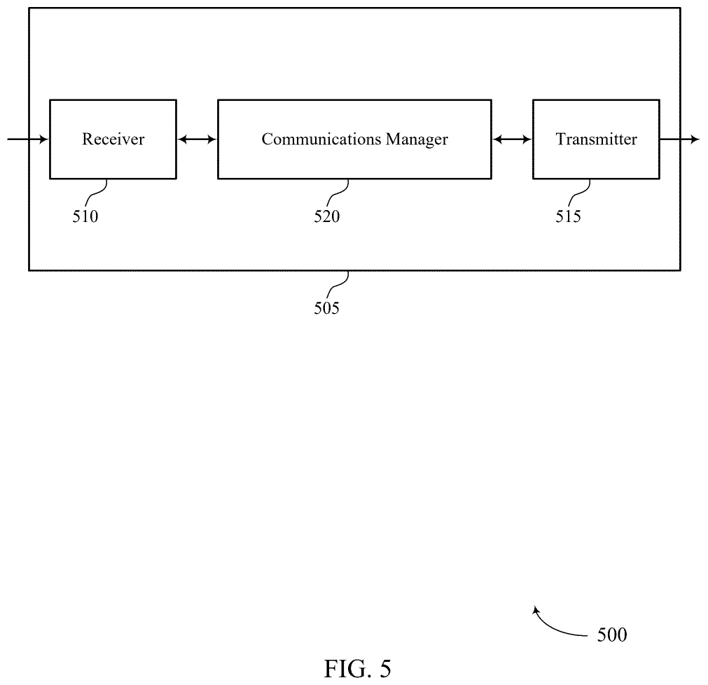

FIG. 5 shows a block diagram 500 of a device 505 that supports handling SI from multiple sources in a communication system in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of handling SI from multiple sources in a communication system as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for obtaining, from a second network entity, one or more first IEs including first SI. The communications manager 520 is capable of, configured to, or operable to support a means for obtaining, from a third network entity, one or more second IEs including second SI. The communications manager 520 is capable of, configured to, or operable to support a means for outputting, based on policy information for SI, a SI configuration that includes one or more third IEs associated with the obtained one or more first IEs, the obtained one or more second IEs, or any combination thereof.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources, improved coordination between devices and functions, and improved utilization of processing capability.

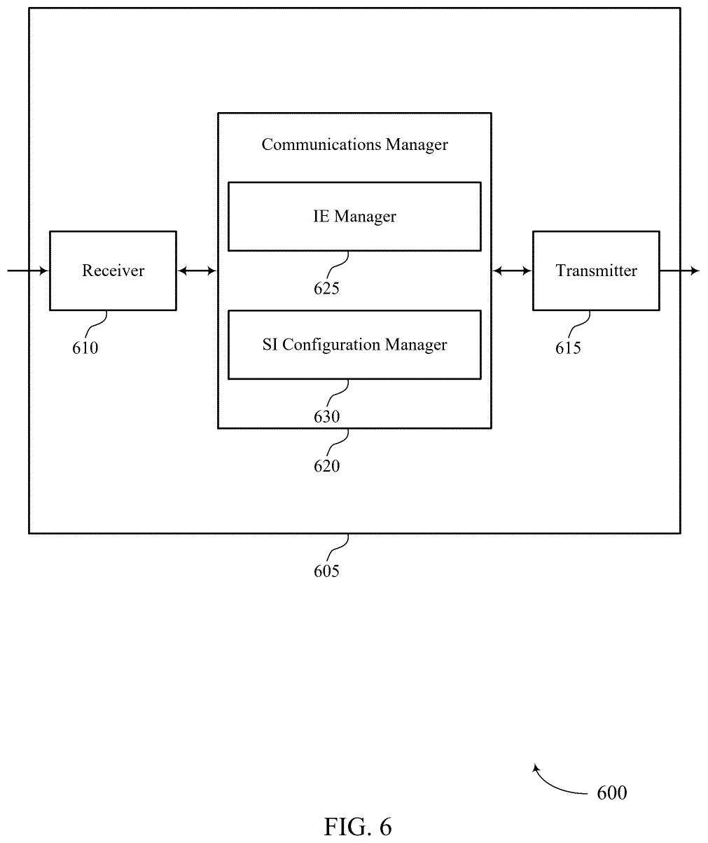

FIG. 6 shows a block diagram 600 of a device 605 that supports handling SI from multiple sources in a communication system in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of handling SI from multiple sources in a communication system as described herein. For example, the communications manager 620 may include an IE manager 625 an SI configuration manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The IE manager 625 is capable of, configured to, or operable to support a means for obtaining, from a second network entity, one or more first IEs including first SI. The IE manager 625 is capable of, configured to, or operable to support a means for obtaining, from a third network entity, one or more second IEs including second SI. The SI configuration manager 630 is capable of, configured to, or operable to support a means for outputting, based on policy information for SI, a SI configuration that includes one or more third IEs associated with the obtained one or more first IEs, the obtained one or more second IEs, or any combination thereof.

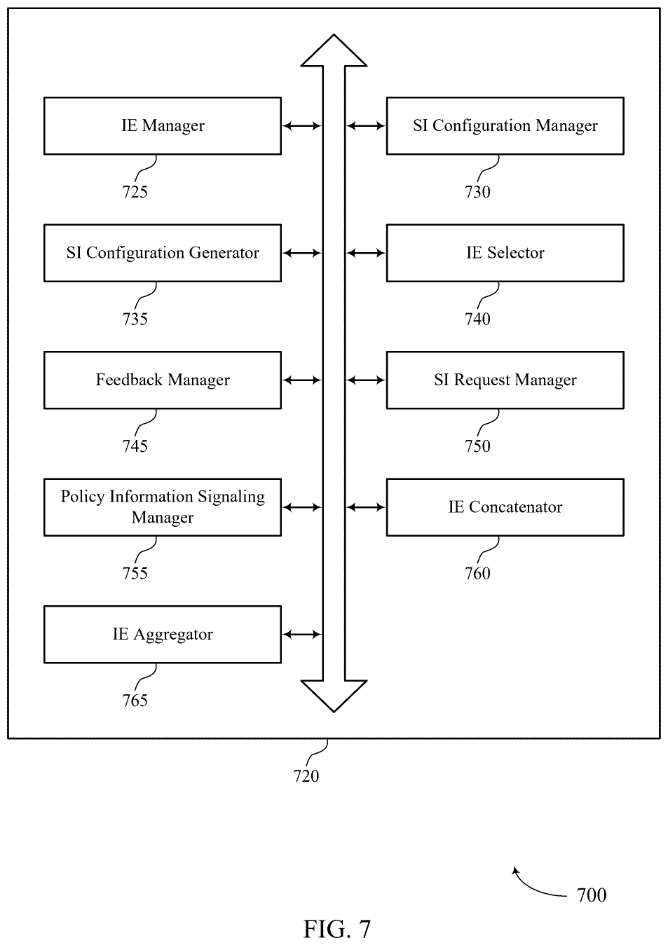

FIG. 7 shows a block diagram 700 of a communications manager 720 that supports handling SI from multiple sources in a communication system in accordance with one or more aspects of the present disclosure. The communications manager 720 may be an example of aspects of a communications manager 520, a communications manager 620, or both, as described herein. The communications manager 720, or various components thereof, may be an example of means for performing various aspects of handling SI from multiple sources in a communication system as described herein. For example, the communications manager 720 may include an IE manager 725, an SI configuration manager 730, an SI configuration generator 735, an IE selector 740, a feedback manager 745, an SI request manager 750, a policy information signaling manager 755, an IE concatenator 760, an IE aggregator 765, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The IE manager 725 is capable of, configured to, or operable to support a means for obtaining, from a second network entity, one or more first IEs including first SI. In some examples, the IE manager 725 is capable of, configured to, or operable to support a means for obtaining, from a third network entity, one or more second IEs including second SI. The SI configuration manager 730 is capable of, configured to, or operable to support a means for outputting, based on policy information for SI, a SI configuration that includes one or more third IEs associated with the obtained one or more first IEs, the obtained one or more second IEs, or any combination thereof.

In some examples, the SI configuration generator 735 is capable of, configured to, or operable to support a means for generating the SI configuration based on aggregating at least one first IE of the obtained one or more first IEs and at least one second IE of the obtained one or more second IEs according to the policy information.

In some examples, to support aggregating the at least one first IE and the at least one second IE, the IE concatenator 760 is capable of, configured to, or operable to support a means for concatenating the at least one first IE with the at least one second IE to form a combined SI element with SI from both of the second network entity and the third network entity, where the SI configuration includes the combined SI element.

In some examples, to support aggregating the at least one first IE and the at least one second IE, the IE aggregator 765 is capable of, configured to, or operable to support a means for aggregating the at least one first IE and the at least one second IE based on one or more rules associated with the at least one first IE, the at least one second IE, or any combination thereof.

In some examples, the IE selector 740 is capable of, configured to, or operable to support a means for selecting the obtained one or more first IEs or the obtained one or more second IEs based on the policy information. In some examples, the SI configuration generator 735 is capable of, configured to, or operable to support a means for generating the SI configuration based on selecting the obtained one or more first IEs or the obtained one or more second IEs.

In some examples, the feedback manager 745 is capable of, configured to, or operable to support a means for outputting, to the second network entity based on outputting the SI configuration, first feedback including conflict resolution information that indicates which first IEs of the obtained one or more first IEs were included in the SI configuration, which second IEs of the obtained one or more second IEs were included in the SI configuration, one or more aggregation techniques used to generate the SI configuration, or any combination thereof. In some examples, the feedback manager 745 is capable of, configured to, or operable to support a means for outputting, to the third network entity based on outputting the SI configuration, second feedback including the conflict resolution information that indicates which first IEs of the obtained one or more first IEs were included in the SI configuration, which second IEs of the obtained one or more second IEs were included in the SI configuration, the one or more aggregation techniques used to generate the SI configuration, or any combination thereof.

In some examples, the first feedback further includes first information associated with at least one first IE of the obtained one or more first IEs not included in the SI configuration; or the second feedback further includes second information associated with at least one second IE of the obtained one or more second IEs not included in the SI configuration; or any combination thereof.

In some examples, the SI request manager 750 is capable of, configured to, or operable to support a means for outputting, to the second network entity, a first request for the second network entity to output the first SI, where obtaining the first SI is based on the first request. In some examples, the SI request manager 750 is capable of, configured to, or operable to support a means for outputting, to the third network entity, a second request for the third network entity to output the second SI, where receiving the second SI is based on the second request.

In some examples, the policy information signaling manager 755 is capable of, configured to, or operable to support a means for obtaining, from a fourth network entity, signaling indicating the policy information, the policy information including first policy information associated with the second network entity, second policy information associated with the third network entity, or any combination thereof, where respective policy information associated with a network entity includes one or more of a priority of the network entity with respect to another network entity, an application or service associated with the network entity, a policy or rule provided by of the network entity, or any combination thereof.

In some examples, to support outputting the SI configuration, the SI configuration manager 730 is capable of, configured to, or operable to support a means for outputting the SI configuration via broadcast signaling, multicast signaling, unicast signaling, or any combination thereof.

In some examples, to support obtaining the one or more first IEs, obtaining the one or more second IEs, or any combination thereof, the IE manager 725 is capable of, configured to, or operable to support a means for obtaining the one or more first IEs, obtaining the one or more second IEs, or any combination thereof via a point-to-point interface in accordance with a request and response signaling type.

In some examples, to support obtaining the one or more first IEs, obtaining the one or more second IEs, or any combination thereof, the IE manager 725 is capable of, configured to, or operable to support a means for obtaining the one or more first IEs, obtaining the one or more second IEs, or any combination thereof via an SBI using application programming interfaces in accordance with a subscribe and notify signaling type.

In some examples, the first SI, the second SI, or any combination thereof includes information for cell selection, information for cell reselection, information for transmitting notifications, timing information, initial access information, information for sidelink communication, positioning information, information for one or more reference signal configurations, information associated with one or more channel configurations, information associated with outputting the SI configuration, or any combination thereof.

In some examples, the first network entity includes a DU or a RAN entity. In some examples, the second network entity and the third network entity each include one or more of a CU, a RAN entity, a server, an OAM protocol, or an SI service.

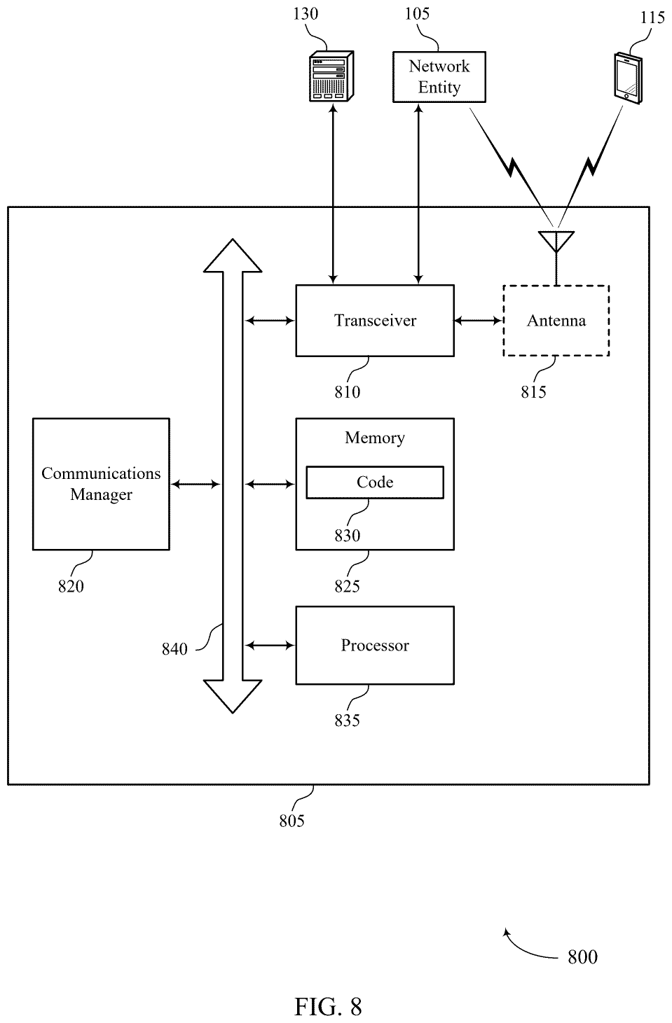

FIG. 8 shows a diagram of a system 800 including a device 805 that supports handling SI from multiple sources in a communication system in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting handling SI from multiple sources in a communication system). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for obtaining, from a second network entity, one or more first IEs including first SI. The communications manager 820 is capable of, configured to, or operable to support a means for obtaining, from a third network entity, one or more second IEs including second SI. The communications manager 820 is capable of, configured to, or operable to support a means for outputting, based on policy information for SI, a SI configuration that includes one or more third IEs associated with the obtained one or more first IEs, the obtained one or more second IEs, or any combination thereof.

By including or configuring the communications manager 820 in accordance with examples as described herein, the device 805 may support techniques for improved communication reliability, more efficient utilization of communication resources, improved coordination between devices, and improved utilization of processing capability.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described herein with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of handling SI from multiple sources in a communication system as described herein, or the at least one processor 835 and the at least one memory 825 may be otherwise configured to, individually or collectively, perform or support such operations.

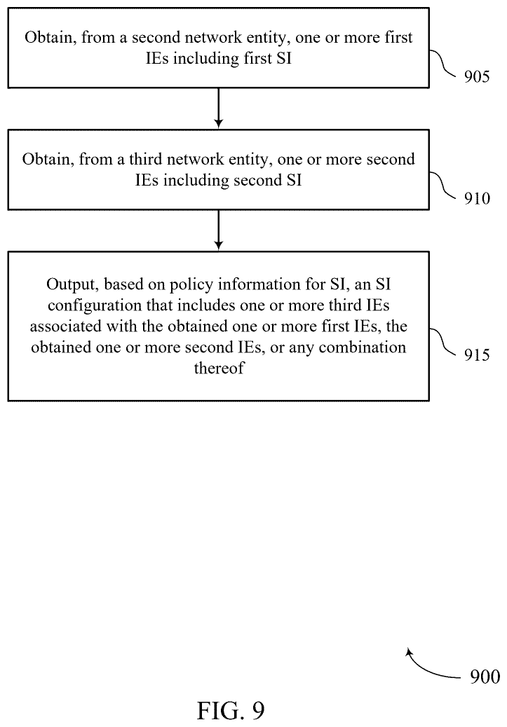

FIG. 9 shows a flowchart illustrating a method 900 that supports handling SI from multiple sources in a communication system in accordance with one or more aspects of the present disclosure. The operations of the method 900 may be implemented by a network entity or its components as described herein. For example, the operations of the method 900 may be performed by a network entity as described herein with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include obtaining, from a second network entity, one or more first IEs including first SI. The operations of 905 may be performed in accordance with examples as disclosed herein. In some examples, aspects of the operations of 905 may be performed by an IE manager 725 as described herein with reference to FIG. 7.

At 910, the method may include obtaining, from a third network entity, one or more second IEs including second SI. The operations of 910 may be performed in accordance with examples as disclosed herein. In some examples, aspects of the operations of 910 may be performed by an IE manager 725 as described herein with reference to FIG. 7.

At 915, the method may include outputting, based on policy information for SI, an SI configuration that includes one or more third IEs associated with the obtained one or more first IEs, the obtained one or more second IEs, or any combination thereof. The operations of 915 may be performed in accordance with examples as disclosed herein. In some examples, aspects of the operations of 915 may be performed by an SI configuration manager 730 as described herein with reference to FIG. 7.

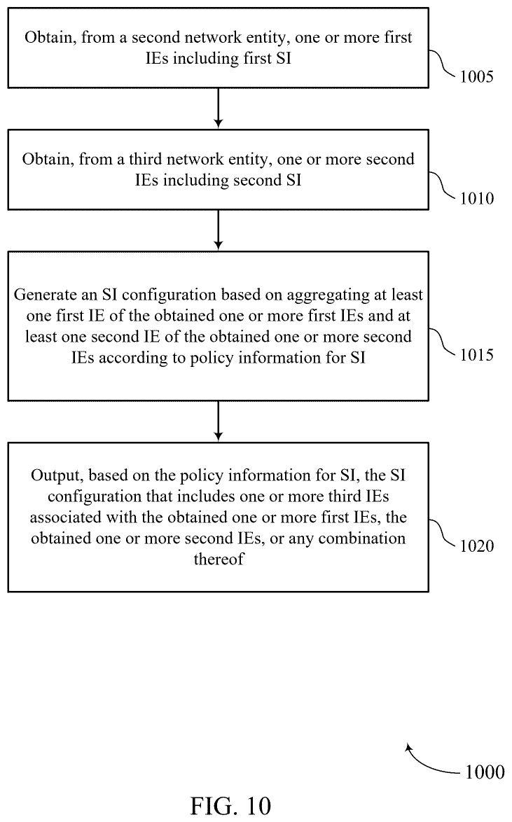

FIG. 10 shows a flowchart illustrating a method 1000 that supports handling SI from multiple sources in a communication system in accordance with one or more aspects of the present disclosure. The operations of the method 1000 may be implemented by a network entity or its components as described herein. For example, the operations of the method 1000 may be performed by a network entity as described herein with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include obtaining, from a second network entity, one or more first IEs including first SI. The operations of 1005 may be performed in accordance with examples as disclosed herein. In some examples, aspects of the operations of 1005 may be performed by an IE manager 725 as described herein with reference to FIG. 7.

At 1010, the method may include obtaining, from a third network entity, one or more second IEs including second SI. The operations of 1010 may be performed in accordance with examples as disclosed herein. In some examples, aspects of the operations of 1010 may be performed by an IE manager 725 as described herein with reference to FIG. 7.

At 1015, the method may include generating an SI configuration based on aggregating at least one first IE of the obtained one or more first IEs and at least one second IE of the obtained one or more second IEs according to policy information for SI. The operations of 1015 may be performed in accordance with examples as disclosed herein. In some examples, aspects of the operations of 1015 may be performed by an SI configuration generator 735 as described herein with reference to FIG. 7.

At 1020, the method may include outputting, based on the policy information for SI, the SI configuration that includes one or more third IEs associated with the obtained one or more first IEs, the obtained one or more second IEs, or any combination thereof. The operations of 1020 may be performed in accordance with examples as disclosed herein. In some examples, aspects of the operations of 1020 may be performed by an SI configuration manager 730 as described herein with reference to FIG. 7.

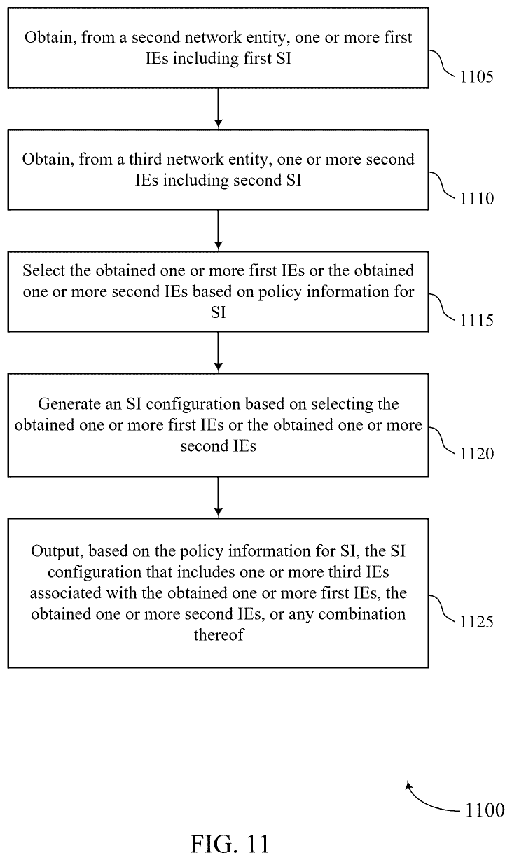

FIG. 11 shows a flowchart illustrating a method 1100 that supports handling SI from multiple sources in a communication system in accordance with one or more aspects of the present disclosure. The operations of the method 1100 may be implemented by a network entity or its components as described herein. For example, the operations of the method 1100 may be performed by a network entity as described herein with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1105, the method may include obtaining, from a second network entity, one or more first IEs including first SI. The operations of 1105 may be performed in accordance with examples as disclosed herein. In some examples, aspects of the operations of 1105 may be performed by an IE manager 725 as described herein with reference to FIG. 7.

At 1110, the method may include obtaining, from a third network entity, one or more second IEs including second SI. The operations of 1110 may be performed in accordance with examples as disclosed herein. In some examples, aspects of the operations of 1110 may be performed by an IE manager 725 as described herein with reference to FIG. 7.

At 1115, the method may include selecting the obtained one or more first IEs or the obtained one or more second IEs based on policy information for SI. The operations of 1115 may be performed in accordance with examples as disclosed herein. In some examples, aspects of the operations of 1115 may be performed by an IE selector 740 as described herein with reference to FIG. 7.

At 1120, the method may include generating an SI configuration based on selecting the obtained one or more first IEs or the obtained one or more second IEs. The operations of 1120 may be performed in accordance with examples as disclosed herein. In some examples, aspects of the operations of 1120 may be performed by an SI configuration generator 735 as described herein with reference to FIG. 7.

At 1125, the method may include outputting, based on the policy information for SI, the SI configuration that includes one or more third IEs associated with the obtained one or more first IEs, the obtained one or more second IEs, or any combination thereof. The operations of 1125 may be performed in accordance with examples as disclosed herein. In some examples, aspects of the operations of 1125 may be performed by an SI configuration manager 730 as described herein with reference to FIG. 7.

The following provides an overview of aspects of the present disclosure:

Aspect 1: A method for wireless communications at a first network entity, comprising: obtaining, from a second network entity, one or more first IEs comprising first SI; obtaining, from a third network entity, one or more second IEs comprising second SI; and outputting, based at least in part on policy information for SI, a SI configuration that comprises one or more third IEs associated with the obtained one or more first IEs, the obtained one or more second IEs, or any combination thereof.

Aspect 2: The method of aspect 1, further comprising: generating the SI configuration based at least in part on aggregating at least one first IE of the obtained one or more first IEs and at least one second IE of the obtained one or more second IEs according to the policy information.

Aspect 3: The method of aspect 2, wherein aggregating the at least one first IE and the at least one second IE comprises: concatenating the at least one first IE with the at least one second IE to form a combined system IE with SI from both of the second network entity and the third network entity, wherein the SI configuration comprises the combined system IE.

Aspect 4: The method of any of aspects 2 through 3, wherein aggregating the at least one first IE and the at least one second IE comprises: aggregating the at least one first IE and the at least one second IE based at least in part on one or more rules associated with the at least one first IE, the at least one second IE, or any combination thereof.

Aspect 5: The method of aspect 1, further comprising: selecting the obtained one or more first IEs or the obtained one or more second IEs based at least in part on the policy information; and generating the SI configuration based at least in part on selecting the obtained one or more first IEs or the obtained one or more second IEs.

Aspect 6: The method of any of aspects 1 through 5, further comprising: outputting, to the second network entity based at least in part on outputting the SI configuration, first feedback comprising conflict resolution information that indicates which first IEs of the obtained one or more first IEs were included in the SI configuration, which second IEs of the obtained one or more second IEs were included in the SI configuration, one or more aggregation techniques used to generate the SI configuration, or any combination thereof; and outputting, to the third network entity based at least in part on outputting the SI configuration, second feedback comprising the conflict resolution information that indicates which first IEs of the obtained one or more first IEs were included in the SI configuration, which second IEs of the obtained one or more second IEs were included in the SI configuration, the one or more aggregation techniques used to generate the SI configuration, or any combination thereof.

Aspect 7: The method of any of aspects 1 through 6, wherein the first feedback further comprises first information associated with at least one first IE of the obtained one or more first IEs not included in the SI configuration; or the second feedback further comprises second information associated with at least one second IE of the obtained one or more second IEs not included in the SI configuration; or any combination thereof.

Aspect 8: The method of any of aspects 1 through 7, further comprising: outputting, to the second network entity, a first request for the second network entity to output the first SI, wherein obtaining the first SI is based at least in part on the first request; and outputting, to the third network entity, a second request for the third network entity to output the second SI, wherein receiving the second SI is based at least in part on the second request.

Aspect 9: The method of any of aspects 1 through 8, further comprising: obtaining, from a fourth network entity, signaling indicating the policy information, the policy information comprising first policy information associated with the second network entity, second policy information associated with the third network entity, or any combination thereof, wherein respective policy information associated with a network entity comprises one or more of a priority of the network entity with respect to another network entity, an application or service associated with the network entity, a policy or rule provided by of the network entity, or any combination thereof.

Aspect 10: The method of any of aspects 1 through 9, wherein outputting the SI configuration comprises: outputting the SI configuration via broadcast signaling, multicast signaling, unicast signaling, or any combination thereof.

Aspect 11: The method of any of aspects 1 through 10, wherein obtaining the one or more first IEs, obtaining the one or more second IEs, or any combination thereof comprises: obtaining the one or more first IEs, obtaining the one or more second IEs, or any combination thereof via a point-to-point interface in accordance with a request and response signaling type.

Aspect 12: The method of any of aspects 1 through 11, wherein obtaining the one or more first IEs, obtaining the one or more second IEs, or any combination thereof further comprises: obtaining the one or more first IEs, obtaining the one or more second IEs, or any combination thereof via a SBI using application programming interfaces in accordance with a subscribe and notify signaling type.

Aspect 13: The method of any of aspects 1 through 12, wherein the first SI, the second SI, or any combination thereof comprises information for cell selection, information for cell reselection, information for transmitting notifications, timing information, initial access information, information for sidelink communication, positioning information, information for one or more reference signal configurations, information associated with one or more channel configurations, information associated with outputting the SI configuration, or any combination thereof.

Aspect 14: The method of any of aspects 1 through 13, wherein the first network entity comprises a DU or a RAN entity, and the second network entity and the third network entity each comprise one or more of a CU, a RAN entity, a server, an OAM protocol, or a SI service.

Aspect 15: A first network entity for wireless communications, comprising one or more memories storing processor-executable code, and one or more processors coupled with the one or more memories and individually or collectively operable to execute the code to cause the first network entity to perform a method of any of aspects 1 through 14.

Aspect 16: A first network entity for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity, comprising:
at least one processor; and
at least one memory coupled with the at least one processor, with instructions stored in the at least one memory, the instructions being executable by the at least one processor, individually or in any combination, to cause the first network entity to:
obtain, from a second network entity, one or more first information elements comprising first system information;
obtain, from a third network entity, one or more second information elements comprising second system information; and
output, based at least in part on policy information for system information, a system information configuration that comprises one or more third information elements associated with the obtained one or more first information elements, the obtained one or more second information elements, or any combination thereof.

2. The first network entity of claim 1, wherein the at least one processor are individually or collectively further operable to execute the instructions to cause the first network entity to:
generate the system information configuration based at least in part on aggregating at least one first information element of the obtained one or more first information elements and at least one second information element of the obtained one or more second information elements according to the policy information.

3. The first network entity of claim 2, wherein, to aggregate the at least one first information element and the at least one second information element, the at least one processor are individually or collectively operable to execute the instructions to cause the first network entity to:
concatenate the at least one first information element with the at least one second information element to form a combined system information element with system information from both of the second network entity and the third network entity, wherein the system information configuration comprises the combined system information element.

4. The first network entity of claim 2, wherein, to aggregate the at least one first information element and the at least one second information element, the at least one processor are individually or collectively operable to execute the instructions to cause the first network entity to:
aggregate the at least one first information element and the at least one second information element based at least in part on one or more rules associated with the at least one first information element, the at least one second information element, or any combination thereof.

5. The first network entity of claim 1, wherein the at least one processor are individually or collectively further operable to execute the instructions to cause the first network entity to:
select the obtained one or more first information elements or the obtained one or more second information elements based at least in part on the policy information; and
generate the system information configuration based at least in part on selecting the obtained one or more first information elements or the obtained one or more second information elements.

6. The first network entity of claim 1, wherein the at least one processor are individually or collectively further operable to execute the instructions to cause the first network entity to:
output, to the second network entity based at least in part on outputting the system information configuration, first feedback comprising conflict resolution information that indicates which first information elements of the obtained one or more first information elements were included in the system information configuration, which second information elements of the obtained one or more second information elements were included in the system information configuration, one or more aggregation techniques used to generate the system information configuration, or any combination thereof; and
output, to the third network entity based at least in part on outputting the system information configuration, second feedback comprising the conflict resolution information that indicates which first information elements of the obtained one or more first information elements were included in the system information configuration, which second information elements of the obtained one or more second information elements were included in the system information configuration, the one or more aggregation techniques used to generate the system information configuration, or any combination thereof.

7. The first network entity of claim 6, wherein:
the first feedback further comprises first information associated with at least one first information element of the obtained one or more first information elements not included in the system information configuration;
the second feedback further comprises second information associated with at least one second information element of the obtained one or more second information elements not included in the system information configuration; or
any combination thereof.

8. The first network entity of claim 1, wherein the at least one processor are individually or collectively further operable to execute the instructions to cause the first network entity to:
output, to the second network entity, a first request for the second network entity to output the first system information, wherein obtaining the first system information is based at least in part on the first request; and
output, to the third network entity, a second request for the third network entity to output the second system information, wherein receiving the second system information is based at least in part on the second request.

9. The first network entity of claim 1, wherein the at least one processor are individually or collectively further operable to execute the instructions to cause the first network entity to:
obtain, from a fourth network entity, signaling indicating the policy information, the policy information comprising first policy information associated with the second network entity, second policy information associated with the third network entity, or any combination thereof, wherein respective policy information associated with a network entity comprises one or more of a priority of the network entity with respect to another network entity, an application or service associated with the network entity, a policy or rule provided by of the network entity, or any combination thereof.

10. The first network entity of claim 1, wherein, to output the system information configuration, the at least one processor are individually or collectively operable to execute the instructions to cause the first network entity to:
output the system information configuration via broadcast signaling, multicast signaling, unicast signaling, or any combination thereof.

11. The first network entity of claim 1, wherein, to obtain the one or more first information elements, obtaining the one or more second information elements, or any combination thereof, the at least one processor are individually or collectively operable to execute the instructions to cause the first network entity to:
obtain the one or more first information elements, obtaining the one or more second information elements, or any combination thereof via a point-to-point interface in accordance with a request and response signaling type.

12. The first network entity of claim 1, wherein, to obtain the one or more first information elements, obtaining the one or more second information elements, or any combination thereof, the at least one processor are individually or collectively further operable to execute the instructions to cause the first network entity to:
obtain the one or more first information elements, obtaining the one or more second information elements, or any combination thereof via a service-based interface using application programming interfaces in accordance with a subscribe and notify signaling type.

13. The first network entity of claim 1, wherein the first system information, the second system information, or any combination thereof comprises information for cell selection, information for cell reselection, information for transmitting notifications, timing information, initial access information, information for sidelink communication, positioning information, information for one or more reference signal configurations, information associated with one or more channel configurations, information associated with outputting the system information configuration, or any combination thereof.

14. The first network entity of claim 1, wherein:
the first network entity comprises a distributed unit or a radio access network entity; and
the second network entity and the third network entity each comprise one or more of a central unit, a radio access network entity, a server, an operations, administration, and management (OAM) protocol, or a system information service.

15. A method for wireless communications at a first network entity, comprising:
obtaining, from a second network entity, one or more first information elements comprising first system information;
obtaining, from a third network entity, one or more second information elements comprising second system information; and
outputting, based at least in part on policy information for system information, a system information configuration that comprises one or more third information elements associated with the obtained one or more first information elements, the obtained one or more second information elements, or any combination thereof.

16. The method of claim 15, further comprising:
generating the system information configuration based at least in part on aggregating at least one first information element of the obtained one or more first information elements and at least one second information element of the obtained one or more second information elements according to the policy information.

17. The method of claim 16, wherein aggregating the at least one first information element and the at least one second information element comprises:
concatenating the at least one first information element with the at least one second information element to form a combined system information element with system information from both of the second network entity and the third network entity, wherein the system information configuration comprises the combined system information element.

18. The method of claim 16, wherein aggregating the at least one first information element and the at least one second information element comprises:
aggregating the at least one first information element and the at least one second information element based at least in part on one or more rules associated with the at least one first information element, the at least one second information element, or any combination thereof.

19. The method of claim 15, further comprising:
selecting the obtained one or more first information elements or the obtained one or more second information elements based at least in part on the policy information; and
generating the system information configuration based at least in part on selecting the obtained one or more first information elements or the obtained one or more second information elements.

20. A non-transitory computer-readable medium storing code for wireless communications, the code comprising instructions executable by at least one processor to:
obtain, from a second network entity, one or more first information elements comprising first system information;
obtain, from a third network entity, one or more second information elements comprising second system information; and
output, based at least in part on policy information for system information, a system information configuration that comprises one or more third information elements associated with the obtained one or more first information elements, the obtained one or more second information elements, or any combination thereof.
